(19) United States
(12) Patent Application Publication
(10) Pub. No.: US 2002/0177988 A1
(43) Pub. Date: Nov. 28, 2002

(54) Method for simulating the dispersion of an electronic circuit for use in an iterative process

(76) Inventors: Gilles Depeyrot, Saint Martin D'Heres (FR); Frederic Poullet, Vizille (FR)

Correspondence Address: DUANE MORRIS LLP, 100 COLLEGE ROAD WEST, SUITE 100, PRINCETON, NJ, 08540-6604, US

(21) Appl. No.: 10/132,891

(22) Filed: Apr. 25, 2002

(30) Foreign Application Priority Data
Apr. 25, 2001 (FR) 01/05547

(51) Int. Cl. G06F 17/50

(52) U.S. Cl. 703/14

(57) ABSTRACT

A method of simulation of an electronic circuit including a plurality of components having variable characteristics, including an initialization step consisting of giving each variable characteristic a value from a set of predetermined values deterministically linked to a single initialization value likely to be memorized.

### BACKGROUND OF THE INVENTION

1. Field of the Invention

The present invention relates to the simulation of electronic circuits and, more specifically, to a simulation method for a statistical analysis of the effect of so-called noisy random variations of the characteristics of some circuit components upon its operation.

2. Discussion of the Related Art

Simulating an electronic circuit enables estimating the circuit operation, evaluating the influence of the operating and circuit manufacturing conditions upon its operation, and evaluating the efficiency of this manufacturing.

The simulation uses a mathematical model, in computer format, representing the circuit operation. If the simulation points out a malfunction, the circuit is modified and simulated again, which then imposes an iterative process, the convergence of which must be ensured.

FIG. 1 schematically shows an example of an integrated circuit 2 including an input terminal I and an output terminal Input I is connected to the base of an NPN-type bipolar transistor T1. The base of transistor T1 is connected to a ground voltage GND by an impedance Z1. The collector of transistor T1 is connected to a supply voltage VDD. The emitter of transistor T1 is connected to the base of an NPN-type bipolar transistor T2. The emitter of transistor T2 is connected to ground GND. The collector of transistor T2 is connected to output terminal O.

FIG. 2 schematically shows an example of a computer model 4 of circuit 2, such as a circuit designer can realize it on a workstation. Model 4 includes an input terminal I and an output terminal O. Transistors T1 and T2 are each represented by a computer model of an NPN-type bipolar transistor T including a base terminal B, a collector terminal C, and an emitter terminal E. Impedance Z1 is represented by a computer model of an impedance Z including two terminals ZI and ZO. Input terminal I is connected to terminal B of a first model T associated with transistor T1 and with terminal ZI of model Z. Terminal C of the first model T is connected to voltage VDD. Terminal E of first model T is connected to terminal B of a first model T associated with transistor T1 and to terminal ZI of model Z. Terminal C of the first model T is connected to terminal B of a second model T associated with transistor T2. Terminals E and C of second model T are respectively connected to ground GND and to output terminal O. Terminal ZO of model Z is connected to voltage GND.

FIG. 3 very schematically shows an example of a structure of simulation file 6 generated from computer model 4. File 6 includes a set L of computer links (symbolized by arrows) between the circuit components and their respective computer models. Set L thus includes a link between impedance Z1 and model Z. Transistors T1 and T2 are linked to the model of bipolar transistor T. File 6 also includes a list N of the connections between the circuit nodes (the circuit terminals and the terminals of its different components) . To simulate the operation of circuit 2, file 6 is provided to a computer, not shown. The computer provides predetermined excitation signals, or test vectors, to input terminal I. By means of the computer models of set L, the computer generates the signals simulating the responses of each component to the received signals. By means of list N, the computer propagates the responses to the consecutive components of the model. The computer memorizes the signals generated by output terminal 0. The computer also enables memorizing, at any time of the simulation, the “state” of each node of the modeled circuit, that is, the summary of its past variations sufficient to calculate its future evolution.

The modeled circuit may include several portions which must be simulated by a different computer (or by a same computer implementing several simulation softwares). Such a circuit (not shown) for example corresponds to a circuit having a digital portion and an analog portion, or a radio-frequency portion and a hyperfrequency portion. A specific simulation file corresponds in such a case to each circuit portion.

In practice, the components of a circuit may have randomly variable characteristics, called aleas or “dispersions”, due to the inaccuracy of the manufacturing process, to the physical behavior of the components, or after a variation of these characteristics along time. The computer models of simulation of the circuit components must enable taking account of these characteristic variations.

FIGS. 4A and 4B schematically show examples of computer models Z′ and T′ of an impedance and of an NPN-type bipolar transistor, respectively, some characteristics of which are variable. Model Z′ includes two terminals ZI and ZO, and the characteristics of resistance R and of capacitance C of impedance Z′ are variable. Characteristics R and C may each vary according to a given dispersion and may be set from a control terminal. Model T′ includes a base terminal B, a collector terminal C, and an emitter terminal E. Characteristics α and β of transistor T′ may also vary according to predetermined dispersions and may be set from a control terminal.

With such computer models, it is possible to form specific sets L in which the variable characteristics of the circuit elements have predetermined values. It is also possible to provide several simulation files 6 each including a set L linked to a specific combination of the variable characteristics of the circuit elements. However, when the circuit includes a great number of components with variable characteristics, it becomes difficult to provide and organize as many simulation files as there are combinations of specific values of the variable characteristics of the circuit components.

A statistical analysis is then generally used. A method of statistical analysis of an electronic circuit, known as the Monte-Carlo analysis method, consists of simulating the circuit a predetermined number of times by assigning to each variable characteristic of the circuit components a value randomly generated by drawing lots for each simulation.

FIG. 5 very schematically shows an example of a simulation file structure enabling Monte-Carlo analysis of preceding circuit 2. File 8 includes a set L′ of links between the circuit elements and their computer models. Impedance Z1 is linked to impedance model Z′. The control terminal of model Z′ is linked to a random value generator 10. Generator 10 is used to generate random values of variable characteristics R and C for each new simulation. Transistors T1 and T2 are linked to transistor model T′. The control terminal of model T′ is linked to a random value generator 12 used to generate random values of variable characteristics α and β for each new simulation. File 8 also includes a list N of the connections of the circuit nodes similar to that of FIG. 3.

FIG. 6 schematically illustrates the development of a Monte-Carlo analysis of circuit 2 using file 8. At a time t₁, by means of file 8, a computer, not shown, “simulates” the response of circuit 2 to test vectors DI, that is, calculates the response by means of the computer models. File 8 uses first randomly chosen values for the variables characteristics of the circuit components. The computer memorizes responses DO1 of the circuit test vectors DI and possibly the internal states of the pertinent variables. The computer reproduces these simulation and memorization operations a predetermined number n of times. For each simulation, file 8 uses randomly-chosen values of the variable characteristics of the circuit elements. The set of responses DOi (where i ranges between 1 and n) is then analyzed by the circuit designer.

FIG. 7 illustrates an arbitrary example of an analysis curve of responses DOi. FIG. 7 illustrates frequency f of a signal provided by output terminal O of the circuit for each simulation. In the example shown, for a specific simulation j, frequency f abruptly drops with respect to an expected frequency of. Such a result means that, for at least one specific combination of the possible values of the variable characteristics of the circuit components, the circuit has a malfunction. The circuit designer must then choose whether such a result is acceptable or not. In the illustrated case, the designer may estimate or not that there is a sufficiently low probability for the circuit to have a malfunction, and that the circuit will generally have a satisfactory operation. Other cases may occur, for example if the circuit operation is not satisfactory in a large number of simulations. If the Monte-Carlo analysis is not satisfactory, the designer may decide to correct the circuit design, for example, by modifying some circuit components. The circuit designer then uses his knowledge of the circuit, refined by the simulations, to determine which component may be the main cause of the malfunction. He can then, for example, modify the dispersion of the variables characteristics of this component and restart a Monte-Carlo analysis to check that the malfunctions have disappeared or that their number has satisfactorily decreased.

With the increase of the complexity of integrated circuits, such an approach of the problem becomes difficult to implement.

A known solution to identify the component(s) responsible of a malfunction revealed by a Monte-Carlo analysis consists of memorizing the values of the variable characteristics used for each simulation. Once a malfunction has been pointed out by a specific simulation, the designer can fill a invariable file, such as file 6 of FIG. 3, with the values memorized in the specific simulation. Such a simulation circuit enables reproducing the simulation in which the problem has appeared by storing, if necessary, the state of all the circuit nodes, which eases the identification of the component(s) causing the malfunction. This method however requires memorizing in addition to the simulation results, all the values of all variable characteristics of all states for each simulation of the Monte-Carlo analysis, which requires a significant memory space. Further, this method requires rewriting a simulation file 6 based on specific values of the variable characteristics of the circuit components, which is relatively long to implement.

This method is particularly unpractical to implement in the case where the simulated circuit includes several portions, each to be simulated by means of a specific simulation file.

### SUMMARY OF THE INVENTION

The present invention aims at overcoming these disadvantages. The present invention more specifically aims at providing a method for simulating an electronic circuit requiring a reduced memory space, enabling statistical analysis of the circuit operation when the characteristics of the circuit components take any values according to predetermined dispersions, and enabling fast determination of the circuit components causing a possible malfunction of the circuit upon analysis.

The present invention also aims at enabling performing a great number of simulations in each of which the variable characteristics of the circuit elements have different random values, while enabling, if the circuit exhibits a malfunction in a specific simulation, rapidly reproducing it, and this even in the case where the circuit must be simulated by means of several specific simulation files.

To achieve these objects, the present invention provides a method for simulating an electronic circuit including a plurality of components having variable characteristics, including an initialization step consisting of giving each variable characteristic a value from a set of predetermined values deterministically linked to a single initialization value likely to be memorized.

According to an embodiment of the present invention, the method further includes the successive steps of:

a/ uniquely choosing an initialization value and performing the initialization step;

b/ successively stimulating the circuit with different predetermined test vectors and memorizing a predetermined number of circuit responses to each test vector, as well as the initialization value; and

c/ repeating steps a/ and b/ a predetermined number of times.

According to an embodiment of the present invention, the method includes step d/ consisting, if the responses memorized in a specific step b/ exhibit anomalies, stimulating the circuit again with said test vectors and with the corresponding initialization value.

According to an embodiment of the present invention, anomalies of the memorized responses consist in a difference between the memorized responses and expected responses.

According to an embodiment of the present invention, the circuit is simulated by means of a simulation file including a list of the connections between the components of the circuit and a list of models of each circuit component, the models of each component having variable characteristics being linked to a single means for generating the set of predetermined values based on a single initialization value.

According to an embodiment of the present invention, the variable characteristics are likely to vary according to predetermined dispersions, and the generation means is likely to have said characteristics vary according to said dispersions.

According to an embodiment of the present invention, first predetermined dispersions are set in a preliminary step, and step d/ further includes determining at least one component with variable characteristics causing at least one anomaly, and modifying the dispersion of the variable characteristics of said at least one component to suppress said at least one anomaly, and repeating step d/ as long as said at least one anomaly is not suppressed.

According to an embodiment of the present invention, the method includes step e/ of repeating steps a/, b/, c/, and d/ until a predetermined number of anomalies is suppressed.

According to an embodiment of the present invention, the single initialization value may be generated by a random value generator.

The foregoing objects, features and advantages of the present invention will be discussed in detail in the following non-limiting description of specific embodiments in connection with the accompanying drawings.

### BRIEF DESCRIPTION OF THE DRAWINGS

FIG. 1, previously described, schematically shows an example of a conventional integrated circuit;

FIG. 2, previously described, schematically shows a computer model of the circuit of FIG. 1;

FIG. 3, previously described, schematically shows a file of simulation of the circuit of FIG. 1;

FIGS. 4A and 4B, previously described, schematically show computer models with variable characteristics of components of the circuit of FIG. 1;

FIG. 5, previously described, schematically shows a simulation file of the circuit of FIG. 1 using the models of FIGS. 4A and 4B;

FIG. 6, previously described, schematically shows a method of Monte-Carlo analysis of the circuit of FIG. 1;

FIG. 7, previously described, schematically illustrates an analysis curve of the results of the method of FIG. 6;

FIG. 8 schematically shows a simulation file according to the present invention of the circuit of FIG. 1;

FIG. 9 schematically shows a method of simulation of circuit 1 by means of the file of FIG. 8;

FIG. 10 schematically illustrates an analysis curve of the results of the method of FIG. 9; and

FIG. 11 schematically illustrates an application of a simulation method according to the present invention.

### DETAILED DESCRIPTION

Same elements have been designated with the same references in the different drawings. Only those elements which are useful to the understanding of the present invention have been shown in the drawings and will be described hereafter. In particular, the making up of computer models adapted to simulating electronic circuits or components is no object of the present invention and has not been detailed.

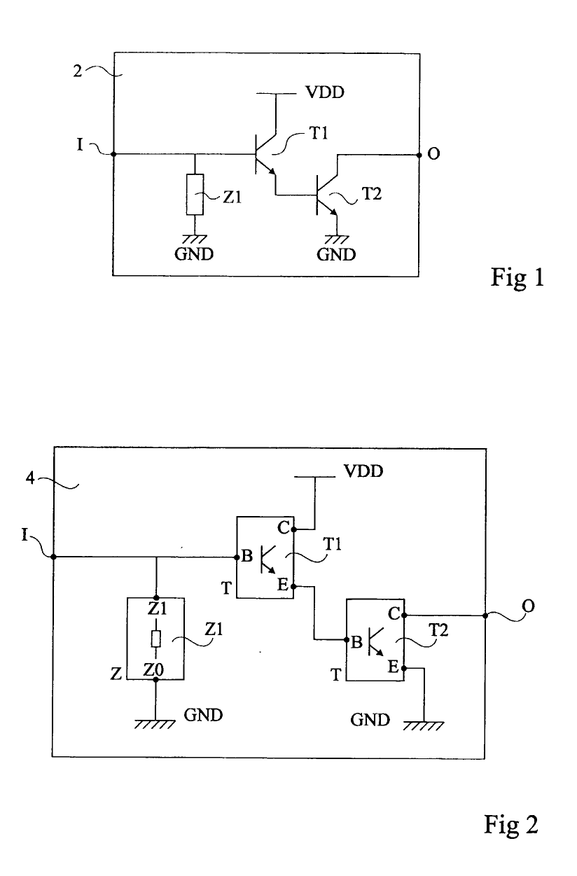

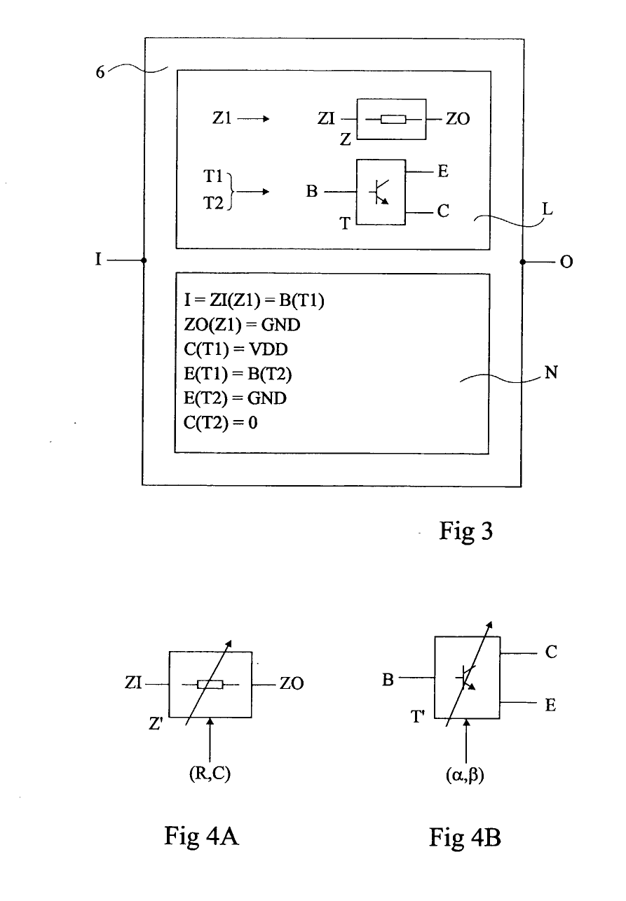

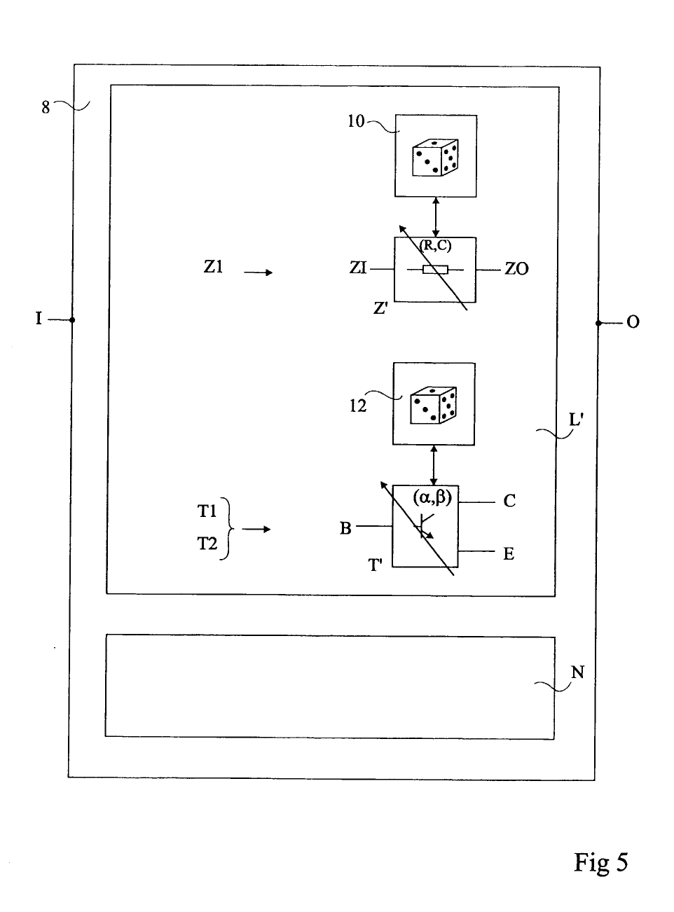

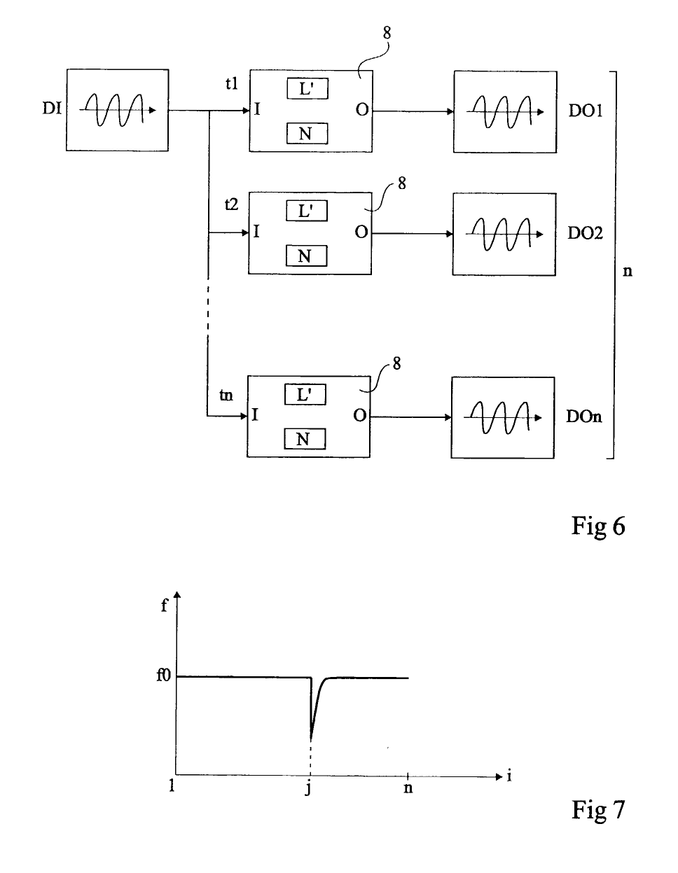

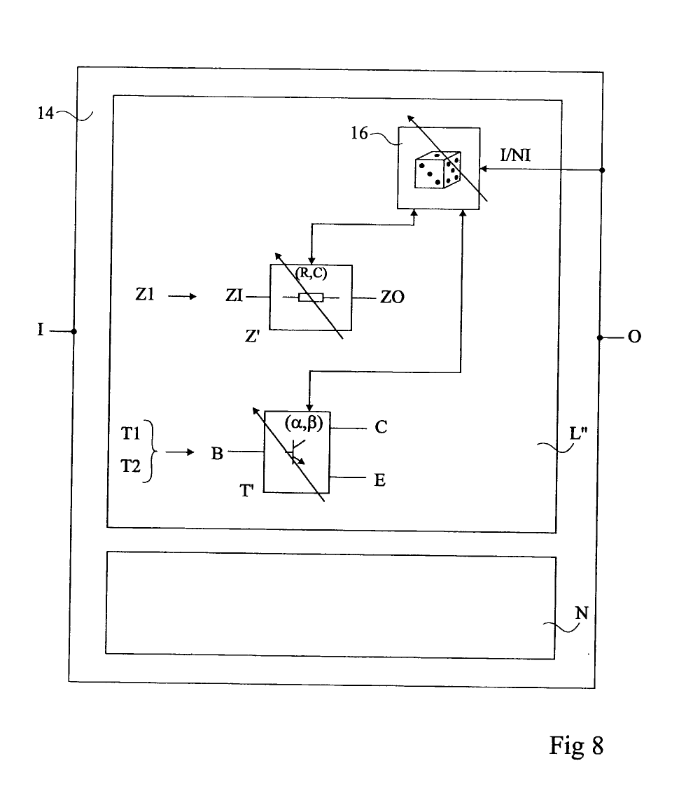

FIG. 8 schematically shows a simulation file 14 according to the present invention of the circuit of FIG. 1. File 14 includes a set L″ of computer links between the circuit components and their computer models. Impedance Z1 is linked to impedance model Z′ described in relation with FIG. 4A. Transistors T1 and T2 are linked to transistor model T′ described in relation with FIG. 4B. According to the present invention, the control terminals of models Z′ and T′ are linked to a single means 16 enabling provision of the values of variable characteristics R, C, α, and β. Means 16 receives an initialization signal INI. Simulation file 14 further includes a conventional list N of the connections between the circuit nodes.

Single means 16 is provided to give, to each characteristic R, C, α, and β, a value from a predetermined set, deterministically linked to initialization value INI. For each initialization value INI, means 16 generates a different set of values, each of which is assigned to one of variable characteristics R, C, α, and β of the circuit components.

In the case (not shown) where the circuit must be simulated by means of several specific simulation files, the values used by each simulation file are generated by means 16 based on a same value INI.

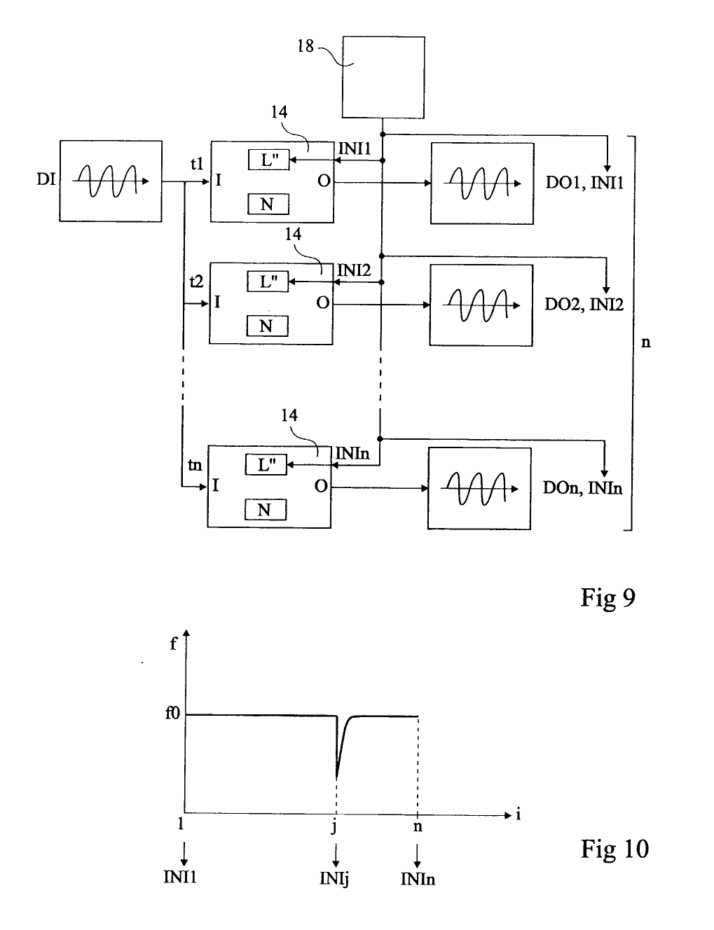

FIG. 9 schematically illustrates a method of simulation of the circuit of FIG. 1 by means of simulation file 14. A computer, not shown, performs a number n of simulations of the circuit by means of file 14 at successive times t1, t2, . . . tn. A value generator 18 provides, in an initialization phase preceding each simulation, an initialization value INli (where i ranges between 1 and n), such that values INI are distinct from one another. The computer performs each of the simulations with one or several test vectors DI common to all simulations. For each simulation i, file 14 thus uses variable characteristics, the values of which are deterministically set by initialization value INli of means 16. The results DOi of each simulation are memorized in association with initialization value INIi of the concerned simulation.

FIG. 10 is an example of an analysis curve of results DOi of the simulations of FIG. 9. FIG. 10 illustrates frequency f of a signal provided by output terminal O of the circuit according to the number of each simulation. According to the present invention, each simulation number i is associated with its initialization value INIi. In the example shown, the simulation having number j exhibits a malfunction, for example, a frequency strongly different from the expected frequency Fo. To analyze this malfunction, it is enough to provide initialization value INIj to simulation file 14, and to simulate the circuit again, memorizing the desired number of circuit nodes. The simulation method according to the present invention thus enables, without substantially increasing the amount of stored data for each simulation, not only statistically analyzing the risks of circuit malfunction when the variable characteristics of the circuit components randomly vary with determined dispersions, but also immediately finding the values of the variable characteristics which cause a malfunction.

The present invention also enables immediately using the values of the variable characteristics which cause the malfunction, for a simulation enabling search of the elements to be questioned.

Of course, the present invention is likely to have various alterations, modifications, and improvements which will readily occur to those skilled in the art. In particular, the analysis of the memorized results enabling detecting whether the circuit exhibits a malfunction or not, for example, by comparing the memorized responses with expected responses, may be implemented by an automatic system within the abilities of those skilled in the art.

Those skilled in the art may also easily adapt the present invention to an automatic system for reproducing unsatisfactory simulations, for automatically detecting which element is responsible for the malfunction and for automatically correcting the circuit.

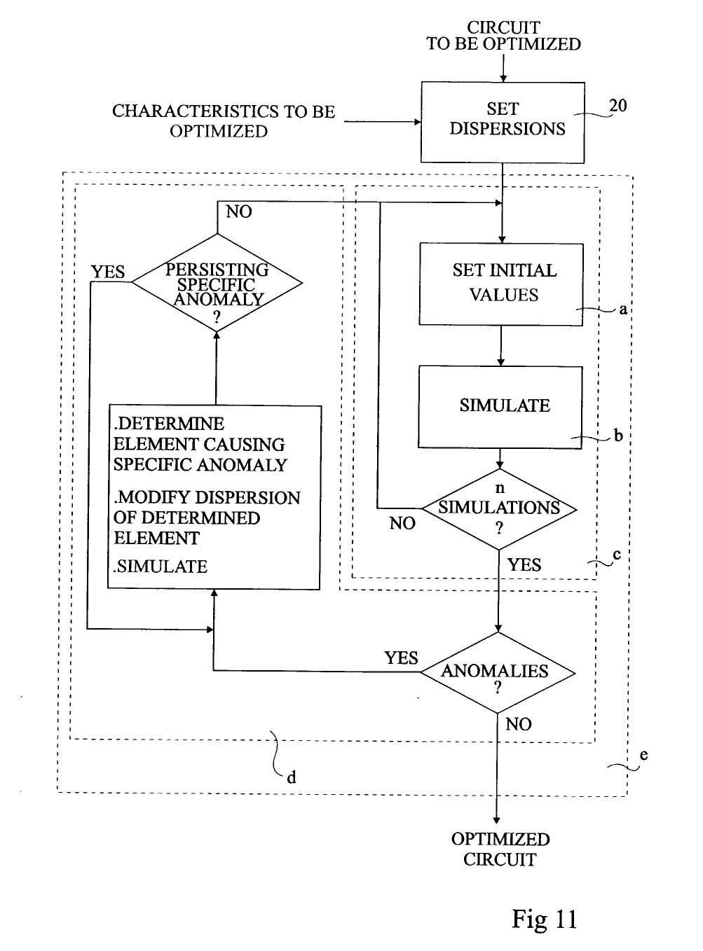

FIG. 11 illustrates an application of the present invention to an automatic circuit design optimization system. The circuit optimization includes the successive steps of:

in a preliminary step 20, providing simulation file 14 of a circuit to be optimized to a computer. Predetermined dispersions are set for the variable characteristics of the circuit components;

a/ uniquely choosing an initialization value (INIi) and using it to initialize file 14;

b/ successively stimulating file 14 with different predetermined test vectors (DI). A predetermined number of responses (DOi) of the circuit to each test vector, as well as initialization value INIi, are memorized;

c/ repeating steps a/ and b/ a predetermined number n of times.

d/ if the responses (DOi) memorized in a specific step b/ (for example, j) exhibit anomalies, modifying the dispersion of the characteristics of at least one component likely to cause at least one of the anomalies, then stimulating the circuit again with said test vectors and with the initialization value INIj corresponding to the specific step b/. Step d/ is repeated until the anomaly has disappeared.

e/ repeating steps a/, b/, c/, and d/ until a predetermined number of or all the anomalies have been suppressed. If a low operating speed or a high consumption are considered as malfunctions, such a system enables optimizing the electric consumption or the speed of the circuit. This automatic optimization system uses the simulator as a tool enabling determination of performances of the circuit, then the present invention to reproduce the simulation(s) exhibiting a malfunction or the poorest performances to determine the responsible components.

Although the present invention has been described in relation with a particularly simple circuit, it applies to any circuit, for example, including several millions of transistors. The present invention applies to analog circuits, to digital circuits or to compound circuits. Similarly, the components with variable characteristics may be complex components such as digital signal processing components (DSP) or microprocessors.

Further, the present invention applies to any circuit, integrated or not, and to any set of circuits, for example, computer boards. The necessary adaptations are within the abilities of those skilled in the art based on the functional indications given hereabove.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method for simulating an electronic circuit (2) including a plurality of components (Z1, T1, T2) having variable characteristics (R, C, α, β), including an initialization step consisting of giving each variable characteristic (R, C, α, β) a value from a set of predetermined values deterministically linked to a single initialization value (INI) likely to be memorized.

2. The simulation method of claim 1, including the successive steps of:
a/ uniquely choosing an initialization value (INIi) and performing the initialization step;
b/ successively stimulating the circuit with different predetermined test vectors (DI) and memorizing a predetermined number of circuit responses (DOi) to each test vector, as well as the initialization value (INIi); and
c/ repeating steps a/ and b/ a predetermined number of times.

3. The simulation method of claim 2, further including the step of:
d/ if the responses (DOi) memorized in a specific step b/ (j) exhibit anomalies, stimulating the circuit again with said test vectors and with the corresponding initialization value (INIj).

4. The simulation method of claim 3, wherein anomalies of the memorized responses consist in a difference between the memorized responses and expected responses.

5. The simulation method of claim 4, wherein the circuit is simulated by means of a simulation file (14) including a list (N) of the connections between the components (Z1, T1, T2) of the circuit (2) and a list of models (Z′, T′) of each circuit component, the models of each component having variable characteristics (R, C, α, β) being linked to a single means (16 ) for generating the set of predetermined values based on a single initialization value (INI).

6. The simulation of claim 5, wherein the variable characteristics (R, C, α, β) are likely to vary according to predetermined dispersions, and the generation means (16) is likely to have said characteristics vary according to said dispersions.

7. The simulation method of claim 6, wherein first predetermined dispersions are set in a preliminary step, and step d/ further includes:
determining at least one component with variable characteristics causing at least one anomaly, and
modifying the dispersion of the variable characteristics of said at least one component to suppress said at least one anomaly, and repeating step d/ as long as said at least one anomaly is not suppressed.

8. The simulation method of claim 7, including step e/ of repeating steps a/, b/, c/, and d/ until a predetermined number of anomalies is suppressed.

9. The simulation method of any of claims 5 to 8, wherein the single initialization value (INI) may be generated by a random value generator (18).
